(19) United States
(12) Patent Application Publication
(10) Pub. No.: US 2003/0056050 A1
(43) Pub. Date: Mar. 20, 2003

(54) Card device

(75) Inventor: Hiroyuki Moro, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/234,114

(22) Filed: Sep. 5, 2002

(30) Foreign Application Priority Data
Sep. 14, 2001 (JP) 2001-280639

(51) Int. Cl. G06F 13/00

(52) U.S. Cl. 710/301

(57) ABSTRACT

An interface unit corresponding to a data pin of an SD memory card comprises a reception buffer having a lead-through current preventing function. The card interface controller validates the lead-through current preventing function when the SD 1-bit mode or SPI mode in which the data lines are not used is designated by a command from a host controller, and invalidates the lead-through current preventing function when the SD 4-bit mode is designated. The safety of the card device is enhanced, and wasteful power consumption is saved.

### CROSS-REFERENCE TO RELATED APPLICATIONS

This application is based upon and claims the benefit of priority from the prior Japanese Patent Application No. 2001-280639, filed Sep. 14, 2001, the entire contents of which are incorporated herein by reference.

### BACKGROUND OF THE INVENTION

1. Field of the Invention

The present invention relates to a card device to be used by attaching to various electronic appliances, and more particularly to a card device having plural operation modes different in the bit width to be used in data transfer.

2. Description of the Related Art

Various portable electronic appliances are developed recently including personal computer, PDA (Personal Digital Assistant), camera and mobile phone. In these electronic appliances, memory cards are widely used as means of removable storage device. Memory cards include PCMCIA (Personal Computer Memory Card International Association) card (PC card), smaller SD (Secure Digital) card, and others.

The SD card is a memory card incorporating a flash memory, and is particularly designed to meet the demands for smaller size, larger capacity, and higher speed. Data communication for the SD card is based on an improved 9-pin interface. Four pins out of nine pins are assigned as data pins usable in data transfer. The SD card is an improved card of multimedia card (MMC) using 7-pin interface, and in order to maintain compatibility of the MMC, three operation modes are supported, that is, SD 4-bit mode, SD 1-bit mode, and SPI (Serial Peripheral Interface) mode.

In the SD 4-bit mode, by using four data pins DAT0 to DAT3, data transfer with the host is executed in 4-bit width unit. In the SD 1-bit mode, only the data pin DAT0 out of DAT0 to DAT3 is used for data transfer with the host, and data transfer with the host is executed in 1-bit width unit. The data pins DAT1 and DAT2 are not used at all. In the SPI mode, the data pin DAT0 is used for data transfer from the card to the host, and another pin is used for data transfer from the host to the card. Same as in the case of SD 1-bit mode, the data pins DAT1 and DAT2 are not used at all.

Thus, since the SD card is designed to assure compatibility of the MMC, only by making a minimum change in the host controller for the MMC, the host controller capable of controlling not only the MMC but also the SD card can be realized.

When building up the system, for example, if the conventional host controller for the MMC is used, and the SD card is installed in a host device which is not properly modified in data lines corresponding to the increased data pins DAT1 and DAT2 in the SD card, in the case the SD 1-bit mode or the SPI mode is designated from the host device, the SD card itself may malfunction, useless current may flow in the internal circuit to consume extra electric power, or the internal circuit itself may be broken due to flow of a large lead-through current between the power source terminal and grounding terminal of the internal circuit. Such phenomenon is caused when the data pins DAT1 and DAT2 of the SD card which are not used in the SD 1-bit mode or the SPI mode are changed to a floating state.

It is hence required to develop a new system of higher safety and capable of suppressing wasteful power consumption as much as possible.

### BRIEF SUMMARY OF THE INVENTION

According to an embodiment of the present invention, a card device which is detachably attachable to a host device, comprises:

data pins;

an internal circuit which is capable of operating in one of a first operation mode for executing data transfer with the host device by using the plural data pins, and a second operation mode for executing data transfer with the host device by using a specific data pin out of the plural data pins;

a data receiving circuit which is connected between the internal circuit and an unused data pin that is not used in the second operation mode and is capable of operating in one of a reception mode for supplying an input signal depending on a potential of the unused data pin to the internal circuit, and a fixing mode for fixing the input signal at a specific potential; and

a data receiving control circuit which sets the data receiving circuit to the reception mode when the internal circuit is set to the first operation mode, and to the fixing mode when the internal circuit is set to the second operation mode.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing the relation between a card device and a host device according to an embodiment of the invention;

FIG. 2 is a block diagram showing a configuration of the card device of the embodiment;

FIG. 3 is a circuit diagram showing an example of a reception buffer to be used in the card device of the embodiment;

FIG. 4 is a circuit diagram showing another example of the reception buffer to be used in the card device of the embodiment;

FIG. 5 is a diagram showing the relation between an operation mode and pin assignment in the card device of the embodiment;

FIG. 6 is a block diagram showing an example of a connection mode of the card device and the host device in the embodiment;

FIG. 7 is a block diagram showing another example of the connection mode of the card device and the host device in the embodiment;

FIG. 8 is a flowchart for explaining the operation of the card device of the embodiment;

FIG. 9 is a block diagram showing a configuration of the card device of the second embodiment; and

FIG. 10 is a flowchart for explaining the operation of the card device in FIG. 9.

### DETAILED DESCRIPTION OF THE INVENTION

An embodiment of a card device according to the present invention will now be described with reference to the accompanying drawings.

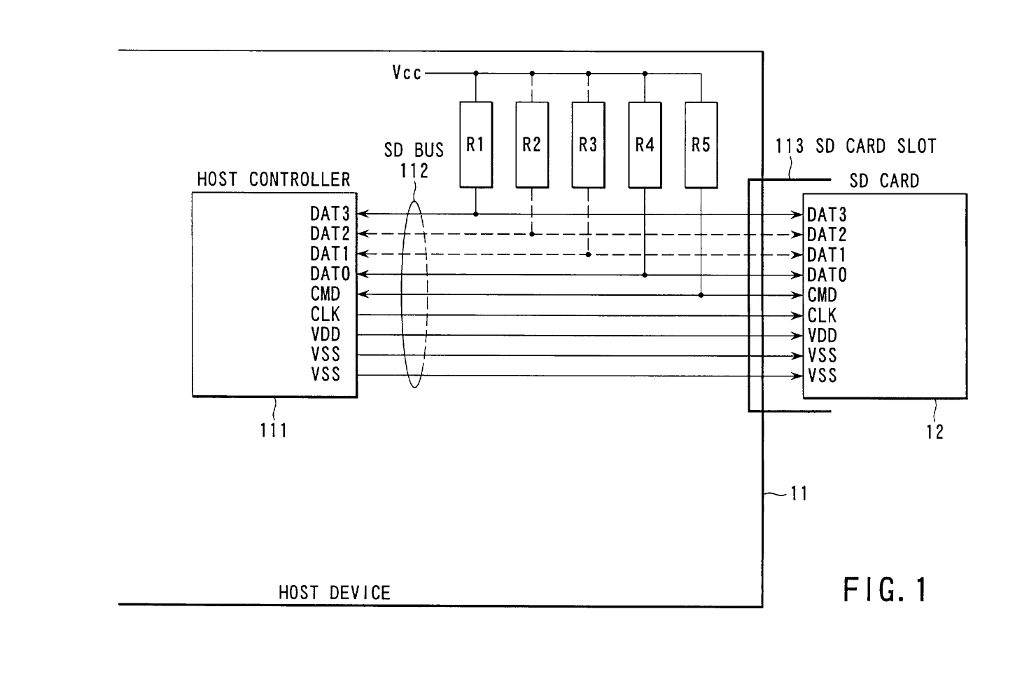

FIG. 1 shows the relation of a card device 12 in an embodiment of the invention, and an electronic appliance (host device) 11 usable by attaching it. Herein, an example of using SD memory card (Secure Digital memory card) as the card device 12 is explained, but the invention is not limited to this card alone, but may be applied also to other cards than the memory card.

The SD memory card 12 is used by detachably attaching to a memory card loading slot (SD card slot) 113 provided in the host device 11, for example, personal computer, PDA, camera, or mobile phone. The host device 11 comprises a host controller 111. Communications between the SD memory card 12 and the host controller 111 are controlled by commands from the host controller 111.

For connecting between the host controller 111 and the SD memory 12, an SD bus 112 comprises six communication lines (DAT0 to DAT3, CMD, CLK, VDD, VSS, VSS). Therefore, the SD memory card 12 comprises four data pins DAT0 to DAT3, command pin CMD, clock signal pin CLK, power supply pin VDD, and two grounding pins VSSs. The functions of the six communication lines (data DAT0 to DAT3, command CMD, and clock CLK) are as follows.

DAT0 to DAT3: Each data line is a bi-directional signal line used in data transfer between the host controller 111 and SD memory card 12. The host controller 111 and SD memory card 12 operate in push-pull mode.

CMD: The command signal line is a bi-directional signal line. It is used in transfer of command from the host controller 111 to the SD memory card 12, and transfer of response from the SD memory card 12 to the host controller 111.

CLK: The clock signal line is a signal line for transmission of clock signal CLK from the host controller 111 to the SD memory card 12. Transfer of command from the host controller 111 to the SD memory card 12, and data transfer between the host controller 111 and the SD memory card 12 are executed in synchronism with the clock signal CLK from the host controller 111 to the SD memory card 12.

Bi-directional data lines DAT3, DAT2, DAT1, DAT0, and command signal line CMD are pulled up to the power source Vcc by means of pull-up resistances R1, R2, R3, R4, R5. These pull-up resistances R1, R2, R3, R4, R5 are provided for preventing the data lines DAT3, DAT2, DAT1, DAT0 and command signal line CMD from being in a floating state while the SD memory card 12 is not inserted, or neither the host controller 111 nor the SD memory card 12 is driving its signal line.

In the SD bus 112, DAT2 and DAT1 are the signal lines which are not used when the SD memory card 12 is used in the SD 1-bit mode or SPI mode. Accordingly, in the host device using the conventional host controller for the MMC which dose not support the SD 4-bit mode directly as the host controller 111, it is possible that data lines DAT2, DAT1 are not wired. In this case, the data pins DAT2, DAT1 of the SD memory card 12 are set to a floating state.

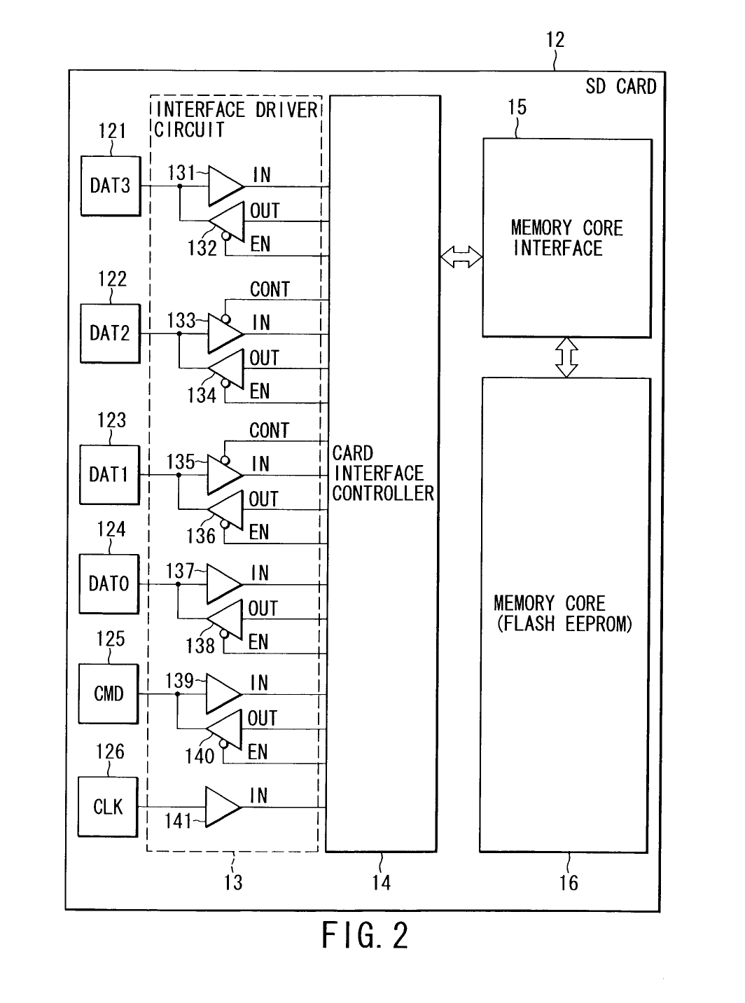

To prevent this, in the SD memory card 12 of the embodiment, a bi-directional buffer having a lead-through current preventing function is used in the interface corresponding to the data pins DAT2, DAT1. A specific configuration of the SD memory card 12 is shown in FIG. 2.

As shown in FIG. 2, the SD memory card 12 incorporates an interface driver circuit 13, card interface controller 14, memory core interface 15, and memory core 16. The memory core 16 comprises nonvolatile memory such as a flash EEPROM.

The card interface controller 14 and memory core interface 15 are internal core circuits for executing the operation (processing the command) in accordance with the command received from the host controller 111 through the interface driver circuit 13. The memory core interface 15 control writing of data into the memory core 16 and reading of data from the memory core 16, in accordance with the command from the host controller 111. The card interface controller 14 mainly controls the communication with the host controller 111, and executes management of operation mode and state of the SD memory card 12. The card interface controller 14 operates in three modes mutually different in the communication protocol, that is, an SD 4-bit mode, SD 1-bit mode, and SPI mode. The command from the host controller 111 designates which operation mode is used for execution of communication with the host controller 111.

The interface driver 13 comprises a driver group for transmitting signals to the SD bus 112 and receiving signals from the SD bus 112.

The driver circuit corresponding to the data pin (DAT3) 121 comprises a bi-directional buffer comprising a receiving buffer 131 and a transmitting buffer 132. The receiving buffer 131 supplies an input signal IN corresponding to the potential of the data pin (DAT3) 121 to the card interface controller 14. The transmitting buffer 132 is, for example, a tristate buffer of open drain type, and when the transmission enable signal EN is set to an active state, the data line DAT3 is driven depending on the output signal OUT from the card interface controller 14. When the transmission enable signal EN is set to an inactive state, the output of the transmitting buffer 132 is set to a high impedance state.

The driver circuit corresponding to the data pin (DAT2) 122 comprises a bi-directional buffer comprising a receiving buffer 133 with lead-through current preventing function and a tristate transmitting buffer 134. The lead-through current preventing function of the receiving buffer 133 is valid when the control signal CONT from the card interface controller 14 is set to an active state, and is invalid when the control signal CONT is set to an inactive state.

When the lead-through current preventing function is invalid (receiving mode), the receiving buffer 133 supplies an input signal IN corresponding to the potential of the data pin (DAT2) 122 to the card interface controller 14. On the other hand, when the lead-through current preventing function is valid (fixed mode), the receiving buffer 133 fixes the potential of the input signal IN at a specific potential corresponding to a logic “H” or logic “L”, regardless of the potential of the data pin (DAT2) 122, so that no effect may occur if the data pin (DAT2) 122 is floating. It hence prevents trouble due to transmission of unspecified potential to the internal circuit. Of course, if the data pin (DAT2) 122 is floating, lead-through current does not flow between the power source terminal and the grounding terminal of the receiving buffer 133.

The transmitting buffer 134 drives the data line DAT2 depending on the output signal OUT from the card interface controller 14 when the transmission enable signal EN from the card interface controller 14 is set to an active state. When the transmission enable signal EN is set to an inactive state, the output of the transmitting buffer 134 is set to a high impedance state.

The driver circuit corresponding to the data pin (DAT1) 123 comprises, same as the driver circuit corresponding to the data pin (DAT2) 122, a bi-directional buffer comprising a receiving buffer 135 having lead-through current preventing function and a tristate transmitting buffer 136. The lead-through current preventing function of the receiving buffer 135 is valid when the control signal CONT from the card interface controller 14 is set to an active state, and is invalid when the control signal CONT is set to an inactive state. The transmitting buffer 136 drives the data line DAT1 depending on the output signal OUT from the card interface controller 14 when the transmission enable signal EN from the card interface controller 14 is set to an active state. When the transmission enable signal EN is set to an inactive state, the output of the transmission buffer 136 is set to a high impedance state.

The driver circuit corresponding to the data pin (DAT0) 124 comprises, same as the driver circuit corresponding to the data pin (DAT3) 121, a bi-directional buffer comprising a receiving buffer 137 and a tristate transmitting buffer 138.

The driver circuit corresponding to the command pin CMD 125 comprises a bi-directional buffer comprising a receiving buffer 139 and a tristate transmitting buffer 140, and the driver circuit corresponding to the clock signal CLK pin 126 comprises a receiving buffer 141 only.

The card interface controller 14 activates the lead-through current preventing function of the receiving buffers 133, 135 when the SD 1-bit mode or SPI mode in which the data lines DAT1, DAT2 are not used is designated by a command from the host controller 111, and inactivates the lead-through current preventing function of the receiving buffers 133, 135 when the SD 4-bit mode is designated by a command from the host controller 111.

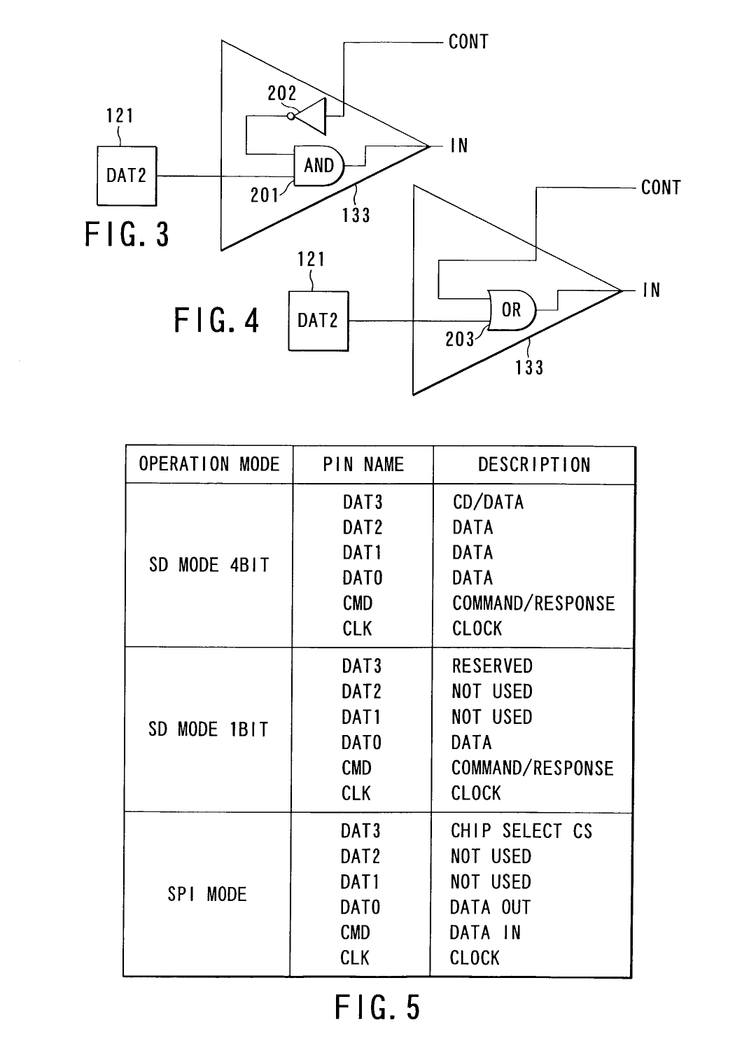

FIG. 3 and FIG. 4 show examples of a circuit configuration of the receiving buffer with the lead-through current preventing function.

FIG. 3 shows a circuit example of the receiving buffer 133 fixing the input signal IN at the “L” level. The receiving buffer 133 comprises two inputs, and the control signal CONT is supplied to one input, and other input terminal is connected to the data pin 121 (DAT2). The control signal CONT is supplied to the first input of a two-input AND gate 201 through an inverter 202, and the potential of the data pin 121 (DAT2) is applied to the second input. When the control signal CONT is set to an inactive state of the “L” level, a signal of the “H” level is supplied to the first input of the AND gate 201, and therefore the AND gate 201 outputs the input signal IN depending on the potential of the data pin 121 (DAT2). On the other hand, when the control signal CONT is set to an active state of the “H” level, a signal of the “L” level is supplied to the first input of the AND gate 201 through the inverter 202, and the AND gate 201 outputs the input signal IN of the “L” level, regardless of the potential of the data pin 121 (DAT2). As a result, the input signal IN is fixed at the “L” level. That is, when the control signal CONT is set to an active state of the “H” level, the operation of the AND gate 201 is dominated by the control signal CONT, and the potential of the data pin 121 (DAT2) has no effect on the operation of the AND gate 201. Accordingly, it is understood that the receiving buffer capable of fixing the output only by the control signal CONT prevents the lead-through current from flowing if the data pin 121 (DAT2) is set to a floating state as far as the control signal CONT is set to an active state.

FIG. 4 shows a circuit example of the receiving buffer 133 when fixing the input signal IN at the “H” level. The receiving buffer 133 comprises two inputs, and the control signal CONT is supplied to one input, and other input terminal is connected to the data pin 121 (DAT2). The control signal CONT is supplied to the first input of a two-input OR gate 203, and the potential of the data pin 121 (DAT2) is applied to the second input. When the control signal CONT is set to an inactive state of the “L” level, the OR gate 203 outputs the input signal IN depending on the potential of the data pin 121 (DAT2). On the other hand, when the control signal CONT is set to an active state of the “H” level, the OR gate 203 outputs the input signal IN of the “H” level, regardless of the potential of the data pin 121 (DAT2). As a result, when the control signal CONT is set to an active state of the “H” level, the operation of the OR gate 203 is dominated by the control signal CONT, and the potential of the data pin 121 (DAT2) has no effect on the operation of the OR gate 203. Accordingly, it is understood that the receiving buffer capable of fixing the output only by the control signal CONT prevents the lead-through current from flowing if the data pin 121 (DAT2) is set to a floating state as far as the control signal CONT is set to an active state.

Such configuration of the receiving buffer with the lead-through current preventing function may be also realized, for example, by inserting a transistor which is turned off by the control signal CONT in an active state between a CMOS gate receiving the potential of the data pin 121 (DAT2) and a power supply terminal or between the CMOS gate and a grounding terminal in order to cut off a path between the power supply terminal and the grounding terminal through the CMOS gate and also inserting a transistor which is turned on by the control signal CONT in an active state between an output terminal of the receiving buffer and the grounding terminal or between the output terminal of the receiving buffer and the power supply terminal in order to fix the output of the receiving buffer at the “L” or “H” level.

Referring now to FIG. 5 to FIG. 7, three operation modes are explained, that is, the SD 4-bit mode, SD 1-bit mode, and SPI mode.

FIG. 5 shows pin assignments in the SD 4-bit mode, SD 1-bit mode, and SPI mode. The operation mode of the SD memory card 12 is roughly classified into the SD mode and SPI mode. In the SD mode, the SD memory card 12 is set to the SD 4-bit mode or SD 1-bit mode by a bus width change command from the host controller 111.

Now turning attention to the four data pins DAT3 to DAT0, in the SD 4-bit mode for transferring data in 4-bit width unit, all of four data pins DAT3 to DAT0 are used in data transfer, but in the SD 1-bit mode for transferring data in 1-bit width unit, only the data pin DAT0 is used in data transfer, while data pins DAT1, DAT2 are not used. The data pin DAT3 is used, for example, in asynchronous interruption from the SD memory card 12 to the host controller 111. In the SPI mode, the data pin DAT0 is used in the data signal line (DATA OUT) from the SD memory card 12 to the host controller 111, and the command pin CMD is used in the data signal line (DATA IN) from the host controller 111 to the SD memory card 12. The data pins DAT1, DAT2 are not used. In the SPI mode, the data pin DAT3 is used in transmission of chip select (CS) signal from the host controller 111 to the SD memory card 12.

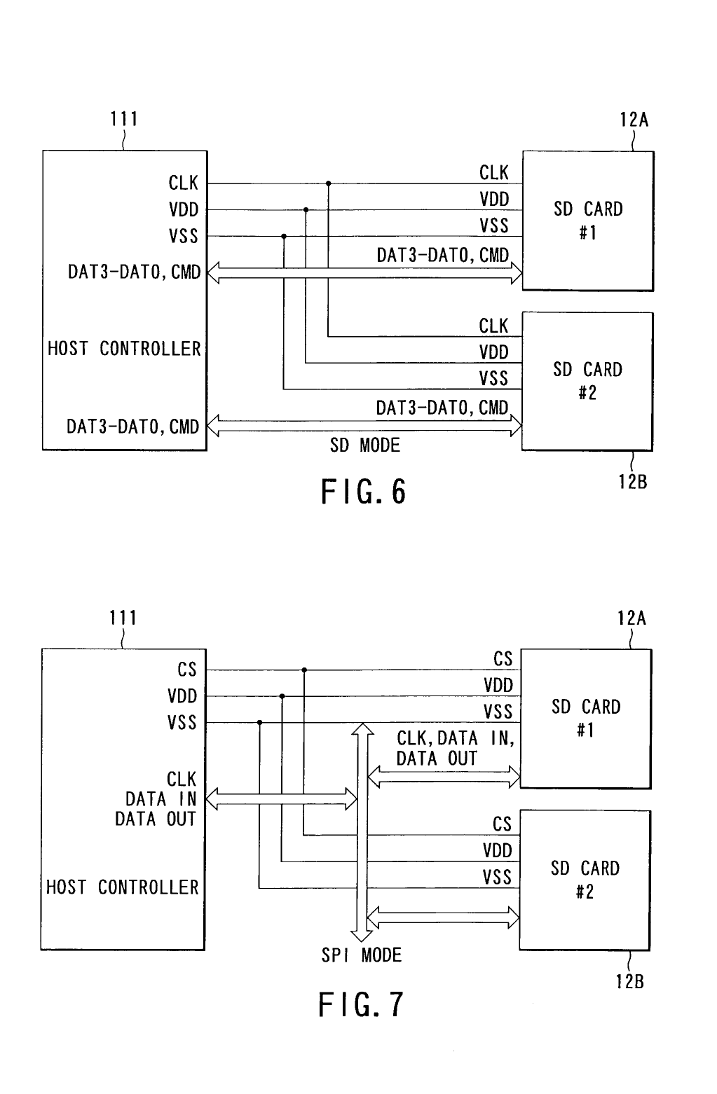

FIG. 6 shows the mode of use of SD bus in the SD modes (SD 4-bit mode, SD 1-bit mode). In the SD mode, in order to control plural SD memory cards 12 by one host controller 111, a synchronous star connection is used as shown in FIG. 6. The clock CLK, power supply VDD, ground VSS are commonly supplied in all SD memory cards 12A and 12B from the host controller 111. The command line CMD and data lines DAT0 to DAT3 are individually provided in the SD memory cards 12A and 12B. In the initializing process of the SD memory cards 12A and 12B, the commands are sent to the individual cards, but after the initializing process, all commands are commonly sent to the SD memory cards 12A and 12B. The cards are selected by broadcasting the command packet including the addressing information to the SD memory cards 12A and 12B. The card selected by the addressing information is required to operate in response to the succeeding command from the host controller 111, but other cards unselected are not required to respond.

FIG. 7 shows a mode of use of SD bus in the SPI mode. In the SPI mode, in order to control plural SD memory cards 12A and 12B by one host controller 111, a bus type connection is used. The clock CLK and data signal lines DATA IN, DATA OUT are commonly connected to each card, and the cards are selected and identified by using a chip select signal CS supplied independently in each card.

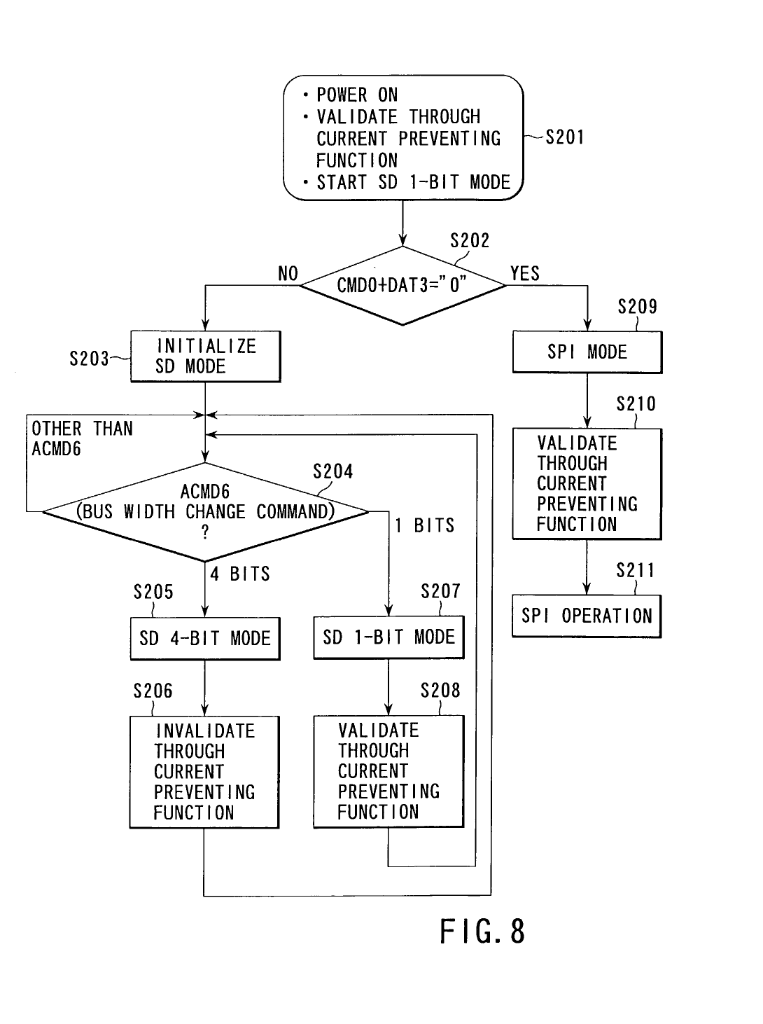

Referring now to the flowchart in FIG. 8, the operation of the SD memory card 12 is explained mainly relating to the control of bi-directional buffer having the lead-through current preventing function.

When the SD memory card 12 is inserted in the host device 11 of a power-on state or when the power of the host device 11 is turned on while the SD memory card 12 is inserted, a power is supplied to the SD memory card 12 from the host controller 111. When the power is supplied, the SD memory card 12 is set to the default SD 1-bit mode, and the control signals CONT corresponding to the receiving buffers 133 (DAT2) and 135 (DAT1) are made active, and the operation is started in the valid state of the lead-through current preventing function of the data pins DAT1 and DAT2 (step S201).

The SPI mode and SD mode are switched over at the first step of initializing process of SD memory card 12, and the host controller 111 outputs a reset command (CMD0) while driving the data line DAT3 in “0”, and transfer to the SPI mode is instructed (step S202). When transfer to the SPI mode is not instructed, initializing process is executed in the SD mode (step S203), and when the initializing process is over, the SD memory card 12 waits for a command (standby state) (step S204).

At step S204, when a bus width change command ACMD6 is received together with an argument of changing to the 4-bit mode, the SD memory card 12 is set to the SD 4-bit mode (step S205), and the control signals CONT corresponding to the receiving buffers 133 (DAT2) and 135 (DAT1) are made inactive, and the lead-through current preventing function of the data pins DAT1 and DAT2 is invalidated (step S206).

On the other hand, in the state being set to the SD 4-bit mode, when a bus width change command ACDM6 is received together with an argument of changing to the 1-bit mode, the SD memory card 12 is set to the SD 1-bit mode (step S207), and the control signals CONT corresponding to the receiving buffers 133 (DAT2) and 135 (DAT1) are made active, and the lead-through current preventing function of the data pins DAT1 and DAT2 is validated (step S208). In the SD mode, by repeating from step S204 to step S206, or from step S204 to step S208, the bus width can be changed over whenever desired, and the lead-through current preventing function of the data pins DAT1 and DAT2 is validated or validated as desired.

As step S202, when the host controller 111 initializes the SPI mode, the SD memory card 12 is set to the SPI mode (step S209), and while the lead-through current preventing function of the data pins DAT1 and DAT2 is kept valid (step S210), the operation is started in the SPI mode (step S211).

In this operation, when the data pins DAT1 and DAT2 of the SD bus 112 are not used, the SD memory card 12 validates the lead-through current preventing function of the data pins DAT1 and DAT2, and therefore even in a system where data lines are not properly wired, troubles due to floating of the data pins DAT1 and DAT2 can be prevented.

According to the first embodiment of the present invention, the card device detachably inserted in the host device comprises plural data pins, an internal circuit to be set to either a first operation mode or a second operation mode depending on a command from the host device, for executing data transfer with the host device by using the plural data pins in the first operation mode, and using a specific data pin out of the plural data pins for data transfer with the host device in the second operation mode, a data receiving circuit connected between a data pin which is not used in the second operation mode and the internal circuit, for operating in a reception mode for supplying an input signal depending on the potential of the data pin to the internal circuit, or in a fixing mode for fixing the potential of the input signal supplied from the data pin to the internal circuit at a specific potential, and a data receiving control circuit for setting the data receiving circuit to the reception mode when the internal circuit is set to the first operation mode, and setting the data receiving circuit to the fixing mode when the internal circuit is set to the second operation mode.

In this card device, one of the first and second operation modes mutually different in the number of data pins used in data transfer is designated by a command from the host device. When the second operation mode smaller in the number of data pins used in data transfer is designated from the host, the data receiving circuit connected between the data pin which is not used in the second operation mode and the internal circuit is automatically set to the fixing mode. As a result, for example, if the host device corresponds only to the second operation mode and the data pins which are not used in the second operation mode are not properly processed, since the potential of the input signal supplied to the internal circuit from the data pins which are not used in the second operation mode is fixed automatically at a specific potential, so that the internal circuit can be protected from the effects of floating. On the other hand, when the first operation mode is designated by the host device, this time, the data receiving circuit connected between the data pin which is not used in the second operation mode and the internal circuit is automatically set to the reception mode, and when this card device is inserted in a normal host device supporting the first operation mode, using the plural data pins, data transfer with the host device can be executed normally.

Other embodiments of the card device according to the present invention will be described. The same portions as those of the first embodiment will be indicated in the same reference numerals and their detailed description will be omitted.

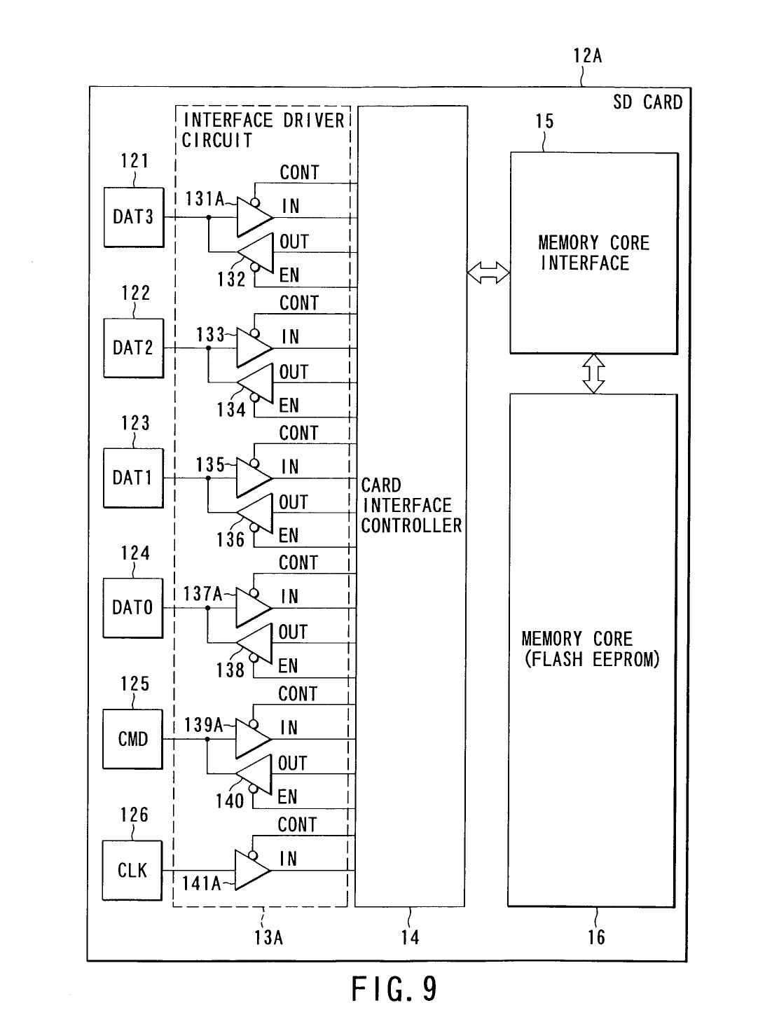

From the viewpoint of saving of power consumption of the SD memory card 12, not only in the data pins DAT1 and DAT2, but also in all other pins receiving signals from the host controller 111, similar lead-through current preventing functions should be provided, and it is desired to validate the lead-through current preventing functions when the corresponding pins are not used to fix the input signal at the “H” or “L” level. As a result, for example, although this SD memory card 12 is not selected, trouble of driving of the gate logic in this SD memory card 12 due to signal addressed to other card can be avoided, and power consumption can be decreased. The second embodiment realizing this configuration of the SD memory card 12 is shown in FIG. 9.

As shown in FIG. 9, in this SD memory card 12A, the lead-through current preventing functions are provided in all receiving buffers 131A, 133, 135, 137A, 139A, and 141A corresponding to the data pin 121 (DAT3) to data pin 124 (DAT0), command pin 125 (CMD), and clock signal pin 126 (CLK). In this case, in addition to the control of changing over validation and invalidation of the lead-through current preventing function of the data pins DAT1 and DAT2 depending on the data transfer bit width as explained in FIG. 8, it is determined whether the pin is necessary or not on the basis of the present state of the SD memory card 12A, and control is executed to change over validation and invalidation of the lead-through current preventing function in each pin depending on the determining result.

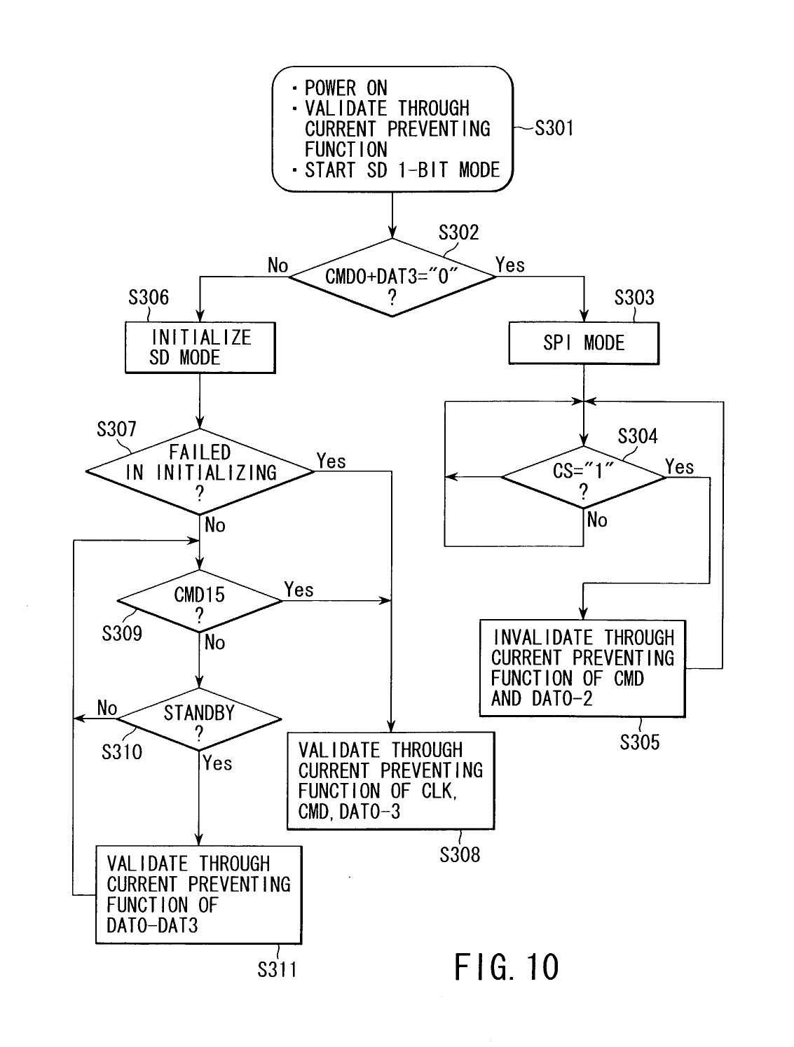

Referring to the flowchart in FIG. 10, the control of changing over validation and invalidation of the lead-through current preventing function on the basis of the state of the card is explained.

When the SD memory card 12A is inserted in the host device 11 of the power-on state or when the power of the host device 11 is turned on while the SD memory card 12A is inserted, the power is supplied to the SD memory card 12A from the host controller 111. When the power is supplied, the SD memory card 12A is set to the default SD 1-bit mode, and the control signals CONT corresponding to the receiving buffers 133 (DAT2) and 135 (DAT1) are made active, and the operation is started in the valid state of the lead-through current preventing function of the data pins DAT1 and DAT2 (step S301). In this case, in other pins than DAT1 and DAT2, that is, in CLK, CMD, DAT0, and DAT3, the lead-through current preventing function is set to an invalid state.

The SPI mode and SD mode are switched over at the first step of initializing process of the SD memory card 12A, and the host controller 111 outputs a reset command (CMD0) while driving the data line DAT3 in “0”, and transfer to the SPI mode is instructed (step S302). When transfer to the SPI mode is not instructed, the initializing process is executed in the SD mode (step S303). In the initializing process, if the operating voltage range designated from the host controller 111 does not match with the operating voltage range of the SD memory card 12A, the initialization fails (step S307), and the SD memory card 12A is set to an inactive state. The inactive state is a state that is not required to respond to any command from the host controller 111, and the lead-through current preventing function is validated in CLK, CMD, DAT0 to DAT3 (step S308).

When the initializing process is normally over, the SD memory card 12A waits for a command (standby state or transfer state). If receiving a command (CMD15) showing transfer to the inactive state (step S309), the SD memory card 12A is transferred to the inactive state, and the lead-through current preventing function is validated in CLK, CMD, DAT0 to DAT3 (step S308).

As for other commands than the command (CMD15) showing transfer to the inactive state, the SD memory card 12A operates according to the command (command processing), and when the command processing is over, it comes to a standby state or transfer state again.

The transfer state is a state corresponding to the status being selected by the host controller 111, and the standby state is a state corresponding to a non-selected status. In the standby state, a command about memory access is not transmitted from the host controller 111. The transfer state is a state of the SD memory card 12A capable of receiving a command about memory access from the host controller 111, that is, to wait for reception of the command about memory access. When the command about memory access is received in the transfer state, the SD memory card 12A is changed to a data transmission state or data reception state depending on the type of the command.

While the SD memory card 12A is set to the standby state (step S310), data transfer with the host controller 111 is not executed, and the lead-through current preventing function is validated in DAT0 to DAT3 (step S311). Receiving a command, when the SD memory card 12A gets away from the standby state, to be ready for data transfer with the host controller 111, the lead-through current preventing function is invalidated in DAT0 to DAT3. In the SD 1-bit mode, whether in standby state or not, the lead-through current preventing function is always validated in DAT1 and DAT2, and only the lead-through current preventing function of DAT0 and DAT3 can be changed between validation and invalidation.

At step S302, when the host controller 111 initializes the SPI mode, the SD memory card 12A is set to the SPI mode (step S303). When the chip select signal CS entered to the data pin DAT3 is “1” (step S303), since this SD memory card 12A is not selected, the lead-through current preventing function is validated in CMD, DAT0 to DAT2 (step S305). In this state, when the chip select signal CS becomes “0”, the lead-through current preventing function is invalidated in CDM and DAT0.

In this process, wasteful consumption of electric power by signals from pins which are not used can be prevented. On the basis of the command waiting condition from the host, the lead-through current preventing function of each data pin may be validated.

According to the second embodiment of the present invention, the card device detachably inserted to the host device comprises an interface having plural data pins used in communication with the host device, a nonvolatile memory device, an internal circuit for controlling data writing into the nonvolatile memory device and data reading from the nonvolatile memory device, depending on an access request from the host device entered through the interface, plural receiving circuits connected to each pin used in reception of signal from the host device out of the plural pins, capable of operating either in a reception mode for supplying an input signal depending on the potential of the pin to the internal circuit, and in a fixing mode for fixing the potential of the input signal supplied from the corresponding pin to the internal circuit at a specific potential, and a receiving control circuit for selecting a receiving circuit which is not necessary in communication with the host device out of the plural receiving circuits, and setting the selected receiving circuit to the fixing mode, in accordance with the command from the host device for designating the bit width to be used in data transfer between the internal circuit and the host device or the present state of the internal circuit.

In this card device, not only in the data pins but also in other pins receiving signals from the host, similar data receiving circuits are provided, and when the corresponding pin is not used, the data receiving circuit is set to the fixing mode. By this control, for example, in a system configuration designed to supply signal from the host device commonly in plural card devices, driving of the gate logic in the non-selected card device by a signal address to other card device is avoided, and power consumption of the card device can be saved.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A card device which is detachably attachable to a host device, comprising:
data pins;
an internal circuit which is capable of operating in one of a first operation mode for executing data transfer with the host device by using the plural data pins, and a second operation mode for executing data transfer with the host device by using a specific data pin out of the plural data pins;
a data receiving circuit which is connected between the internal circuit and an unused data pin that is not used in the second operation mode and is capable of operating in one of a reception mode for supplying an input signal depending on a potential of the unused data pin to the internal circuit, and a fixing mode for fixing the input signal at a specific potential; and
a data receiving control circuit which sets the data receiving circuit to the reception mode when the internal circuit is set to the first operation mode, and to the fixing mode when the internal circuit is set to the second operation mode.

2. The device according to claim 1, wherein the data receiving circuit comprises:
a control signal input terminal which receives a control signal from the data receiving control circuit;
a potential input terminal to which the potential of the unused data pin is input;
an output terminal connected to the internal circuit; and
a logic gate which comprises input terminals connected to the potential input terminal and control signal input terminal, fixes a potential of the output terminal at a logic level of one of “1” and “0” when the control signal is set to an active state, and sets the potential of the output terminal depending on a potential of the potential input terminal when the control signal is set to an inactive state, and
the data receiving control circuit sets the control signal to an active state when the internal circuit is set to the second operation mode, and to an inactive state when the internal circuit is set to the first operation mode.

3. The device according to claim 1, wherein the data receiving control circuit comprises:
a setting circuit which sets the data receiving circuit to the fixing mode in response to supply of power from the host device to the memory card; and
a controller which changes the data receiving circuit from the fixing mode to the reception mode when the first operation mode is designated, and maintains the data receiving circuit in the fixing mode when the second operation mode is designated.

4. The device according to claim 1, wherein
the internal circuit is set to one of the first and second operation modes depending on a bus width change command from the host device for designating a bit width to be used in data transfer with the host device, and
the data receiving control circuit sets the data receiving circuit to one of the reception mode and fixing mode depending on the bit width designated by the bus width change command.

5. The device according to claim 1, further comprising:
a command pin for receiving a command from the host device;
a command receiving circuit which is connected between the command pin and the internal circuit and is capable of operating in one of a command reception mode for supplying an input command signal depending on a potential of the command pin to the internal circuit, and a command fixing mode for fixing the input command signal at a specific potential; and
a command receiving control circuit which sets the command receiving circuit to one of the command reception mode and command fixing mode depending on an operation mode of the internal circuit.

6. The device according to claim 1, further comprising:
a clock pin for receiving a clock signal from the host device;
a clock receiving circuit which is connected between the clock pin and the internal circuit and is capable of operating in one of a clock reception mode for supplying an input clock signal depending on a potential of the clock pin to the internal circuit, and a clock fixing mode for fixing the input clock signal at a specific potential; and
a clock receiving control circuit which sets the clock receiving circuit to one of the clock reception mode and clock fixing mode depending on an operation mode of the internal circuit.

7. The device according to claim 1, further comprising:
a second data receiving circuit which is connected between the internal circuit and the specific data pin that is used in the second operation mode and is capable of operating in one of a second reception mode for supplying a second input signal depending on a potential of the specific data pin to the internal circuit, and a second fixing mode for fixing the second input signal at a second specific potential; and
a second data receiving control circuit which sets the second data receiving circuit to one of the second reception mode and second fixing mode depending on an operation mode of the internal circuit.

8. A card device which is detachably attachable to a host device, comprising:
an interface having pins to be used in communication with the host device;
a nonvolatile memory device;
an internal circuit which controls writing of data into the nonvolatile memory device and reading of data from the nonvolatile memory device depending on an access request supplied from the host device through the interface;
receiving circuits which are connected between the internal circuit and pins and is capable of operating in one of a reception mode for supplying an input signal depending on a potential of the pins to the internal circuit, and a fixing mode for fixing the input signal at a specific potential; and
a receiving control circuit which selects a receiving circuit that is not necessary in communication with the host device out of the receiving circuits in accordance with a command from the host device for designating a bit width to be used in data transfer between the internal circuit and host device or a present state of the internal circuit, and sets the selected receiving circuit to the fixing mode.

9. The device according to claim 8, wherein
the pins comprises data pins for transferring data; and
the receiving control circuit selects a data pin that is not necessary for transferring data out of the data pins in accordance with the bit width, and sets the receiving circuit corresponding to the selected data pin to the fixing mode.

10. The device according to claim 8, wherein
the pins comprises data pins for transferring data; and
the receiving control circuit determines whether or not the internal circuit is set to a standby state in which data is not transferred between the host device and the card device through the data pins, and sets the receiving circuit corresponding to the selected data pin to the fixing mode when the internal circuit is set to the standby state.

11. The device according to claim 8, wherein the receiving control circuit determines whether or not the internal circuit is set to an inactive state in which it is not necessary to respond to any command from the host device, and sets the receiving circuits to the fixing mode when the internal circuit is set to the inactive state.

12. The device according to claim 8, wherein
the pins comprises data pins for transferring data and a chip select signal pin for receiving a chip select signal from the host device; and
the receiving control circuit determines whether the chip select signal indicates an active state showing the card device is selected or an inactive state showing the card device is not selected, and sets receiving circuits corresponding to the data pins to the fixing mode when the chip select signal indicates an inactive state.
